(19) United States
(12) Patent Application Publication
(10) Pub. No.: US 2021/0406940 A1
(43) Pub. Date: Dec. 30, 2021

(54) INTER-APPLICATION GAME ACHIEVEMENT NORMALIZATION

(71) Applicant: ZeeRabbit Inc., New York, NY (US)

(72) Inventors: Yoanna A. GOUCHTCHINA, Allen, TX (US); Denis G. GUSHCHIN, Moscow (RU); Dmitry N. MEDVEDEV, Moscow (RU)

(21) Appl. No.: 17/474,775

(22) Filed: Sep. 14, 2021

Related U.S. Application Data
(63) Continuation of application No. 13/970,492, filed on Aug. 19, 2013, now abandoned.
(60) Provisional application No. 61/691,194, filed on Aug. 20, 2012.

(51) Int. Cl. G06Q 30/02

(52) U.S. Cl. CPC G06Q 30/0209

(57) ABSTRACT

An inter-application game achievement system for providing a normalized measure of player achievement across multiple games/applications, which need not share a common scoring system. The inter-application normalized measure of player achievement may be adjustable such that system points accumulate at rates that encourage users of varying skill levels to keep obtaining and using/playing applications/games.

### FIELD

This disclosure is directed to providing normalized measures of inter-application user achievement in games.

### BACKGROUND OF THE INVENTION

Many people enjoy playing games and using other applications on various computing devices, including laptops, desktops, and other personal computing devices; smart phones, tablets, personal digital assistants, and other mobile computing devices; as well as video game consoles, handheld video game consoles, set-top boxes, digital media receivers, smart appliances, and other suitable computing devices.

Computer games, including casual games, serious games, educational games, and the like, typically involve one or more goals that players seek to achieve during game play. Similarly, non-game applications may also involve achievements that a user may reach by use of the application.

Frequently, a game or other application may measure the player's progress and/or achievements according to a scoring system using quantitative measures, referred to in general as “points”. In some cases, several games on a given platform may share a common scoring system, such that 100 points accumulated in one game are equivalent to 100 points accumulated in another game. However, game developers may not wish to conform a given game to a common scoring system, and/or it may be difficult to retrofit an existing game to conform to the dictates of a common scoring system.

More frequently, different games and other applications may use different scoring systems, awarding varying quantities of points for various achievements. For example, in one game, typical players might accumulate on the order of 100 points in a typical gaming session, while in another application, typical users might accumulate on the order of 10,000 points in a typical application session. Thus, “points” awarded in different games or other applications are not easily comparable.

In some types of games, a player may exchange “points” earned in a given game for virtual goods (e.g., a magic sword) to alter future game play in that game. In some cases, game developers may also allow players to spend “real-world” currency on such virtual goods, thereby monetizing the game play for the developer.

In other cases, application developers may monetize a application by displaying advertisements during application use, during pauses in game use, or the like. Conversely, advertisers may be willing to pay “real-world” currency (either to a developer directly or via a third party, such as an ad network) in order to display the advertiser's promotional content to application users.

However, many application users and some developers may dislike in-application promotional content, which may demand the user's attention without providing a perceptible benefit, thereby detracting from the application experience. Thus, existing application-promotion systems may fail to satisfy the desires of developers, who wish to be monetarily compensated for producing applications; game players and application users, who wish to enjoy playing games and using applications without distraction and/or interruption from promotional content and to perceive some benefit from devoting their attention to promotional content; and advertisers, who wish to engage players and users with promotional content.

### BRIEF DESCRIPTION OF THE DRAWINGS

FIG. 1 illustrates a conceptual overview of one embodiment of an inter-application-redemption platform.

FIG. 2 illustrates a simplified interapplication-redemption system in which inter-application redemption server, offer provider, and client computing device are connected to network.

FIG. 3 illustrates several components of an exemplary inter-application redemption server in accordance with one embodiment.

FIG. 4 illustrates an exemplary series of communications between inter-application redemption server, client computing device, client computing device, and offer provider in accordance with one embodiment.

FIG. 5 illustrates a routine for processing activity reports, such as may be performed by an inter-application redemption server in accordance with one embodiment.

FIG. 6 illustrates a subroutine for computing a normalized system-point-award value award from a given activity report, such as may be performed by an inter-application redemption server in accordance with one embodiment.

FIG. 7 illustrates a subroutine for updating a given APP_PlayerPointBase value for a given user, a given duration, and a given reporting application, such as may be performed by an inter-application redemption server in accordance with one embodiment.

FIG. 8 illustrates a routine for processing promotional-offer descriptions, such as may be performed by an inter-application redemption server in accordance with one embodiment.

FIG. 9 illustrates a routine for processing an offer-redemption request, such as may be performed by an inter-application redemption server in accordance with one embodiment.

FIG. 10 illustrates a subroutine for distributing a developer-portion of an offer-redemption currency-cost, such as may be performed by an inter-application redemption server in accordance with one embodiment.

FIGS. 11-14 illustrate aspects of an exemplary user interface, such as may be displayed on a client computing device in accordance with one embodiment.

### DETAILED DESCRIPTION OF THE INVENTION

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

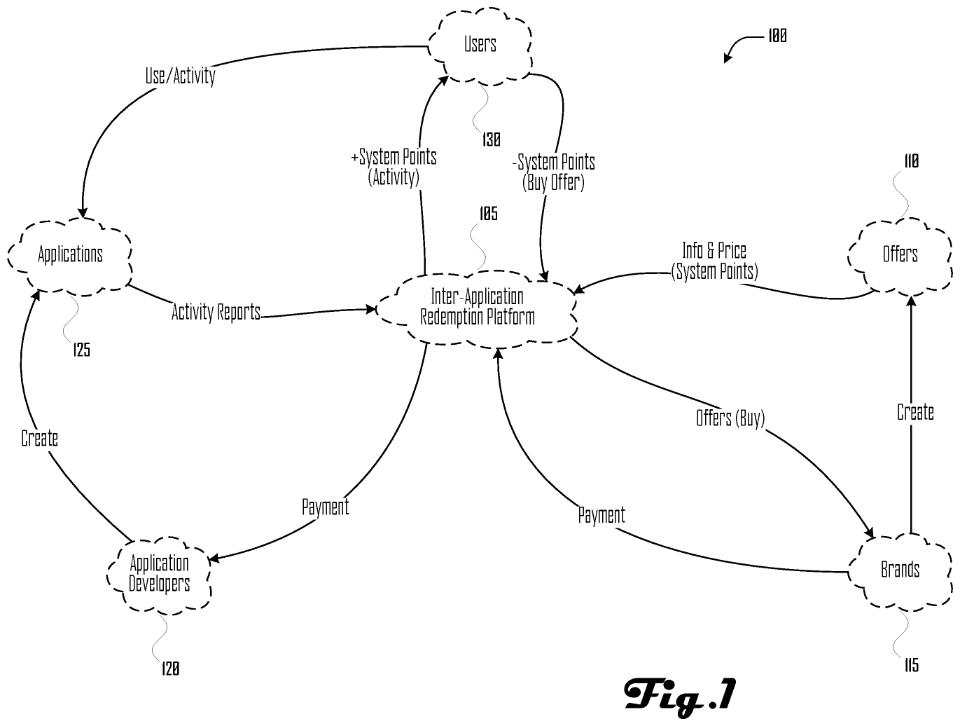

FIG. 1 illustrates a conceptual overview 100 of one embodiment of an inter-application-redemption platform. In various embodiments, as discussed further below, applications 125, created by, published by, or otherwise associated with developers 120 may collect, enable, and/or report application-use or other activity by users 130 to an inter-application redemption platform 105. The inter-application redemption platform 105 may provide a normalized measure of user achievement (referred to as “system points” or similar) across multiple applications 125. The applications 125 need not share a common achievement-scoring system. Brands 115 can provide promotional offers 110 for presentation to application users 130. Users 130 can redeem such promotional offers 110 in exchange for the normalized inter-application user achievement points. In some embodiments, the inter-application normalized measure of user achievement may be adjustable such that system points accumulate at rates that encourage users of varying skill levels to keep obtaining and using/playing applications/games, and to keep redeeming promotional offers.

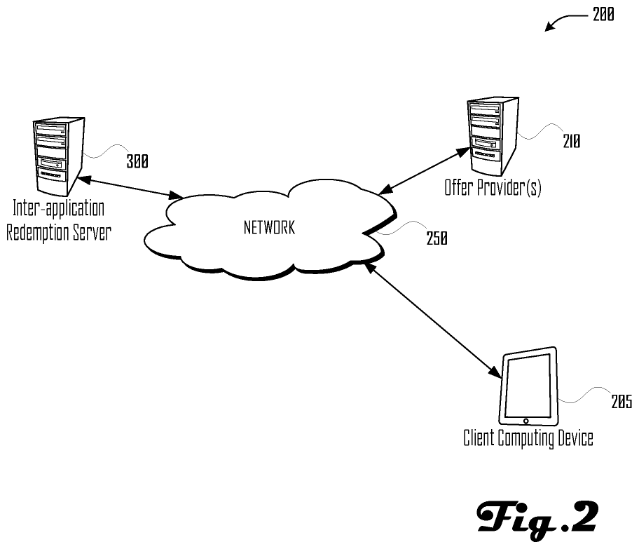

FIG. 2 illustrates a simplified interapplication-redemption system in which inter-application redemption server 300, offer provider 215, and client computing device 205 are connected to network 250.

In various embodiments, network 250 may include the Internet, a local area network (“LAN”), a wide area network (“WAN”), and/or other data network.

In various embodiments, additional infrastructure (e.g., cell sites, routers, gateways, firewalls, and the like), as well as additional devices may be present. Further, in some embodiments, the functions described as being provided by some or all of inter-application redemption server 300 and offer provider 215 may be implemented via various combinations of physical and/or logical devices. However, it is not necessary to show such infrastructure and implementation details in FIG. 2 in order to describe an illustrative embodiment.

As discussed further below, in an exemplary scenario, an individual may use client computing device 205 or a similar device to play one or more computer games and/or use one or more computer applications, thereby accumulating some quantity of application-specific achievement “points” in each game and/or application.

Client computing device 205 uses network 250 to report to inter-application redemption server 300 the player's achievements, including game/application points earned and other metadata, such as the duration of time in which the user achieved the game points, the player's identity, and the like. Inter-application redemption server 300 uses the metadata to convert the game points into normalized “system points”, which the user may redeem for offers provided by offer provider 215.

In many embodiments, two or more of client computing device 205 and/or offer provider 215 may be present.

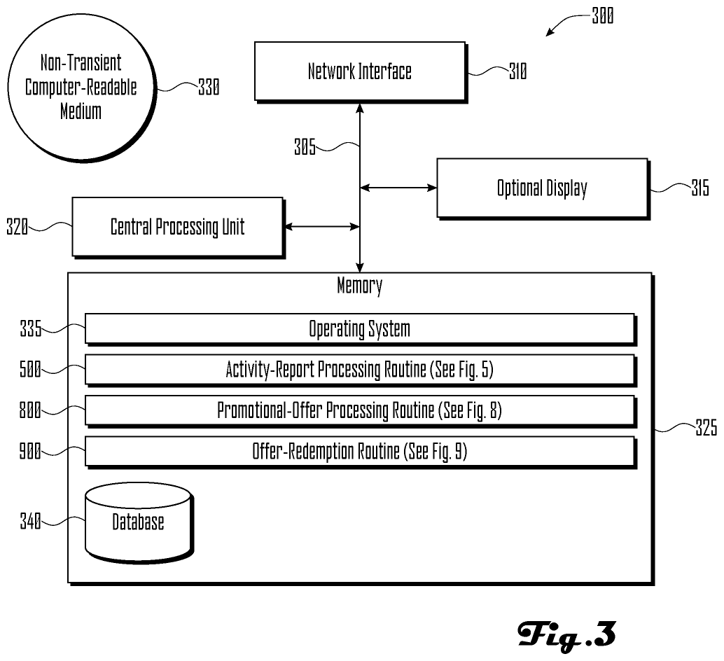

FIG. 3 illustrates several components of an exemplary inter-application redemption server in accordance with one embodiment. In some embodiments, inter-application redemption server 300 may include many more components than those shown in FIG. 3. However, it is not necessary that all of these generally conventional components be shown in order to disclose an illustrative embodiment.

In various embodiments, inter-application redemption server 300 may comprise one or more physical and/or logical devices that collectively provide the functionalities described herein. In some embodiments, inter-application redemption server 300 may comprise one or more replicated and/or distributed physical or logical devices.

In some embodiments, inter-application redemption server 300 may comprise one or more computing services provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

Inter-application redemption server 300 includes a bus 305 interconnecting several components including a network interface 310, an optional display 315, a central processing unit 320, and a memory 325.

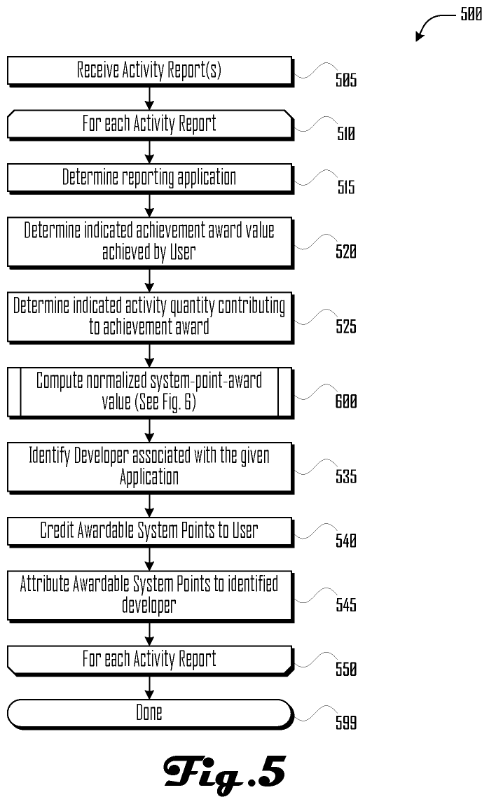

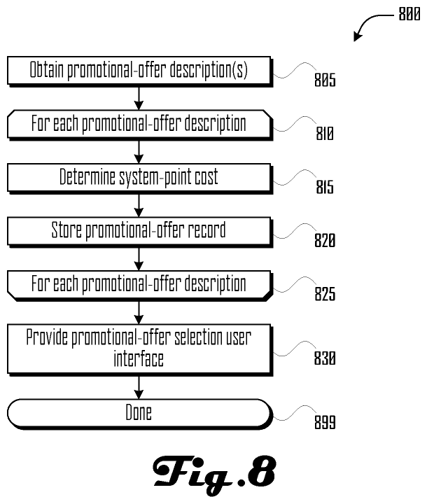

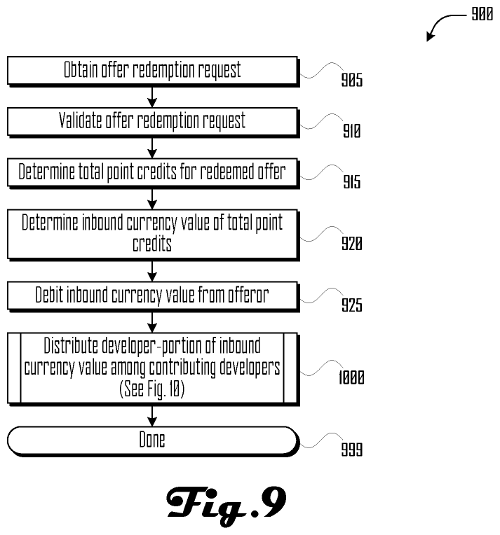

Memory 325 generally comprises a random access memory (“RAM”), a read only memory (“ROM”), and a permanent mass storage device, such as a disk drive. The memory 325 stores program code for a routine 500 for processing activity reports (see FIG. 5, discussed below); a routine 800 for processing promotional-offer descriptions (see FIG. 8, discussed below); and a routine 900 for processing an offer-redemption request (see FIG. 9, discussed below). In addition, the memory 325 also stores an operating system 335.

These and other software components may be loaded into memory 325 of inter-application redemption server 300 using a drive mechanism (not shown) associated with a non-transient computer-readable medium 330, such as a floppy disc, tape, DVD/CD-ROM drive, memory card, or the like.

Memory 325 also includes database 340. In some embodiments, inter-application redemption server 300 may communicate with database 340 via network interface 310, a storage area network (“SAN”), a high-speed serial bus, and/or via the other suitable communication technology.

In some embodiments, database 340 may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

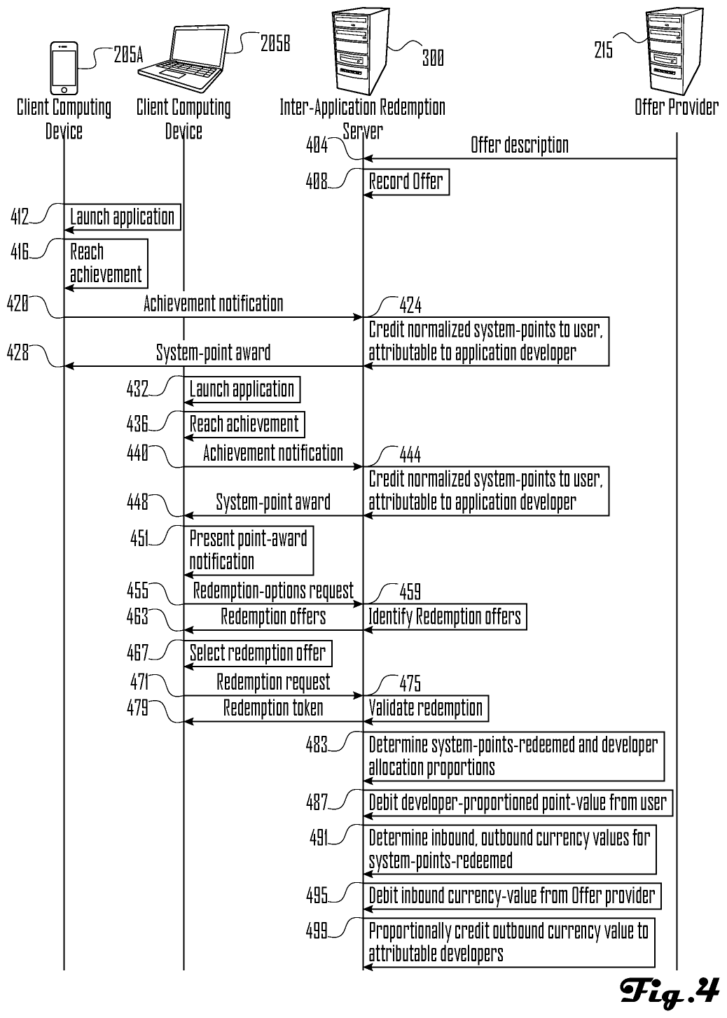

FIG. 4 illustrates an exemplary series of communications between inter-application redemption server 300, client computing device 205B, client computing device 205A, and offer provider 215 in accordance with one embodiment. The communications shown in FIG. 4 do not encompass every combination of possibilities in which the systems and methods provided herein may be employed. Rather, the illustrated communications merely provide an overview of one simplified example scenario in which inter-application redemption server 300 processes application points reports by client computing device 205A and client computing device 205B and presents offers provided by offer provider 215, in accordance with one embodiment. Additional variations and alternatives are described more fully in the Figures and description that follow.

Beginning the illustrated sequence of communications, offer provider 215 sends to inter-application redemption server 300 offer description data 404 describing one or more promotional offers that the offer provider wishes to be made available to application users in exchange for “points”. For example, in various embodiments, offer providers may wish to promote a brand and/or drive traffic to a virtual or physical storefront by offering discounts, gifts, or the like to users who wish to redeem points they have earned while using one or more computer applications. In various embodiments, the data describing the promotional offers may include data such as a “cost” (in system points) of the offer (e.g., 1000 points), a description of the offer (e.g., “10% of any regular-priced item”), as well as promotional copy and/or creative assets to be displayed to the user in connection with the offer.

Inter-application redemption server 300 records 408 (e.g. in database 340) the data associated with the offer(s) for subsequent retrieval and use.

Meanwhile, at some point in time, a user launches an application 412 on client computing device 205A and uses the application.

After using for some duration of time, the user reaches an achievement 416 for which the user is awarded some quantity of “points” in the application. In various embodiments, a given application may characterize such achievement-based “points” as virtual currency, coins, or some other quantitative token, any of which is considered equivalent to “points” as the term is used herein.

The user having reached an achievement for which the user is awarded in-application points, client computing device 205A sends to inter-application redemption server 300 a notification 420 identifying at least the user, the application, and the quantity of application points that were awarded to the user, and the quantity of time that the user used the application to achieve the application-point award.

In many embodiments, different applications may award differing quantities of points for achievements of varying difficulty. For example, one application may award 1000 application points for completing a level that typically takes ten minutes to complete, while another application may award 100 application points for reaching an achievement that typically takes an hour of use time. Belatedly, in a given application, a novice user may spend 30 minutes achieving the same quantity of points that an accomplished user may be able to achieve in five minutes. However, the offer-redemption system may have a goal to entice users of all skill levels to continue using many different applications to accumulate points that the users can redeem for a finite group of offers.

Consequently, using methods such as those described further herein, inter-application redemption server 300 may convert 424 the achievement reported by client computing device 205A into a quantity of normalized system points, which are credited to the user and attributed to the developer of the application that the user used.

Inter-application redemption server 300 sends to client computing device 205A data 428 describing the quantity of normalized system points into which the user's achievement was converted.

At some other point in time, the user may use client computing device 205B (or client computing device 205A) to launch 432 a different application (or the same application).

After using the application or otherwise using the application for some period of time, the user may reach another in-application achievement 436.

Client computing device 205B sends to inter-application redemption server 300 an achievement notification 440.

Inter-application redemption server 300 converts 444 the reported achievement to normalized system points. As described above, the normalized system points are credited to the user and attributed to the application developer.

Inter-application redemption server 300 sends to client computing device 205B the system-point award 448.

In the illustrated scenario, client computing device 205B notifies 451 the user of the system points that have been credited to the user, and the user may now activate a control indicating the user's wish to redeem some or all of the user's accumulated system-points in exchange for one or more promotional offers.

Client computing device 205B sends to inter-application redemption server 300 a request 455 for one or more promotional offers that are available to the user for redemption. In some embodiments, the request may include one or more selection criteria (e.g., category, geolocation, or the like).

Using any selection criteria that may have been provided, inter-application redemption server 300 identifies 459 one or more promotional offers that are available for the user to redeem.

Inter-application redemption server 300 sends to client computing device 205B data 463 describing the available offers.

Client computing device 205B presents the available offers to the user and provides a user interface by which the user may select 467 an offer for redemption.

Once the user has selected an offer, client computing device 205B sends to inter-application redemption server 300 a redemption request 471 identifying the selected offer.

Inter-application redemption server 300 validates the offer redemption 475 to make it more difficult for bad actors to game the system.

When the redemption is determined to be likely valid, inter-application redemption server 300 sends to client computing device 205B a token 479 that the user can use to obtain the offer. For example, in one embodiment, the token may include a human- or machine-readable code (e.g., a one- or two-dimensional bar code, an alphanumeric string, or the like) that when presented at a physical or virtual storefront, will entitle the user to a discount on certain merchandise, a gift, or the like.

Meanwhile, the user having redeemed some number of system points for a promotional offer, inter-application redemption server 300 determines 483 how to allocate those system-points-redeemed among the developers of the applications that contributed to the user's system point total. For example, in one embodiment, if a user redeemed 1000 system points in exchange for a promotional offer from offer provider 215, and the user had accumulated 50% of the user's system points from using application “A” (developed by developer “A”) and 50% of the user's system points from using application “B” (developed by developer “B”), then inter-application redemption server 300 may determine to allocate 500 system-points-redeemed to each of developers A and B.

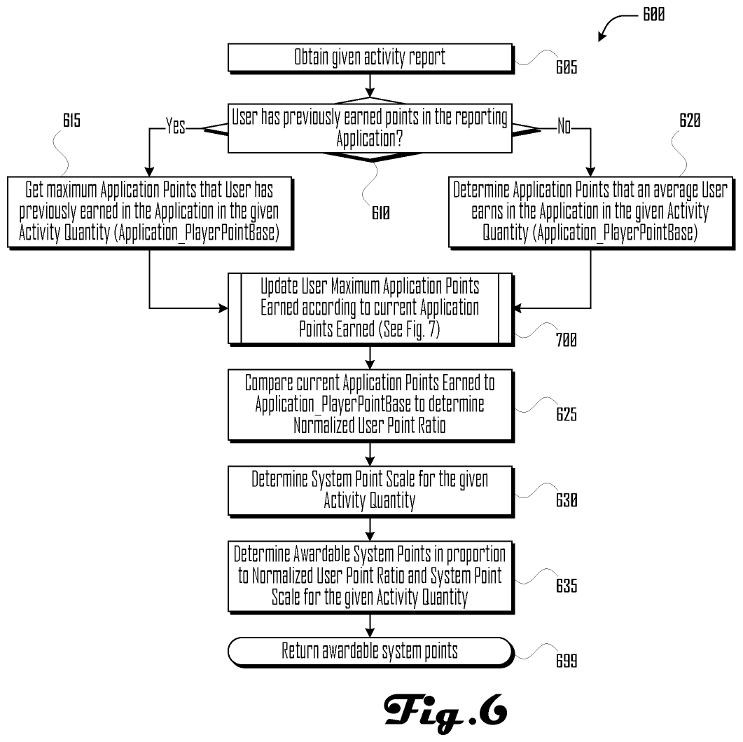

As discussed briefly above, system points credited to a user are also attributable to a particular developer. Having allocated the system-points-redeemed among one or more developers, inter-application redemption server 300 debits 487 developer-proportioned quantities of system points from the user's system-point total (see FIG. 6, discussed below). For example, in one embodiment, if a user had earned 1000 system points each from using applications A and B, and if the user redeems 1000 of those points for a promotional offer, then after the 1000 system-points-redeemed are debited from the user's system-point total, the user may have 1000 total system points, 500 of which are attributable to each of developers A and B.

Inter-application redemption server 300 determines 491 inbound and outbound “real-world” currency values for the quantity of system points that the user redeemed. For example, in one embodiment, a system point may have an “inbound” currency value (e.g., 0.00075 USD) that is greater than an “outbound” currency value (e.g., 0.000375 USD). Consequently, in such an embodiment, 1000 system-points-redeemed may have an inbound currency value of 0.75 USD and an outbound currency value of 0.375 USD.

Having determined inbound and outbound currency values for system-points-redeemed, inter-application redemption server 300 debits 495 the inbound currency value from an account associated with the provider of the offer that was redeemed.

Inter-application redemption server 300 further proportionally credits 499 the outbound currency value to the developer(s) to which the system-points-redeemed are attributable. In other words, in one embodiment, when a user redeems an offer for 1000 system points, the offer provider may be charged 0.75 USD, and application developers A and B may be credited a total of 0.375 USD (e.g., 0.1875 USD each to developers A and B if A and B contributed equally to the user's system point total).

FIG. 5 illustrates a routine 500 for processing activity reports, such as may be performed by an inter-application redemption server 300 in accordance with one embodiment.

In block 505, routine 500 receives, via one or more applications executing on at least one client computing device 205, one or more activity reports reporting on activities associated with an indicated user. For example, in one embodiment, an activity report may include data indicating a quantity of game points (e.g., 450) that have been earned by a given user playing a given game over a given time duration (e.g., 30 minutes). For example, in one embodiment, a client (e.g., client computing device 205) may send such data to routine 500 across a network when the user is awarded points in the game. In other embodiments, a non-game application may send data indicating similar non-game achievements.

Beginning in opening loop block 510, routine 500 processes each activity report in turn.

In block 515, routine 500 identifies the reporting application that was responsible for facilitating, capturing, and/or reporting the current activity report. For example, in some embodiments, the reporting application may be a game. In other embodiments, the reporting application may be a non-game computing application.

In block 520, routine 500 determines an indicated achievement-award value measuring an achievement reached by the user. The achievement-award value is denominated in an application-specific unit of achievement. For example, in one embodiment, routine 500 may determine that the indicated achievement-award value measures an achievement as being worth 1000 “points” or “gold coins”, or the like.

In block 525, routine 500 determines an indicated activity quantity measuring an amount of an activity performed by the user that contributed to reaching the achievement. The indicated activity quantity is denominated in a unit of activity, such as hours, minutes, days, or other non-time-based activity-quantity units, such as a number of words written, number of articles viewed, or the like. For example, in one embodiment, the indicated activity quantity may measure an amount of an activity in time units, such as seconds, minutes, hours, or the like. In other embodiments, the indicated activity quantity may measure an amount of an activity in an application-determined non-time unit.

In subroutine block 600, routine 500 calls subroutine 600 (see FIG. 6, discussed below) to compute a normalized system-point-award value measured according to a non-application-specific unit of achievement. For example, in one embodiment, routine 500 may call subroutine 600 to convert 1000 “gold coins” into some number of normalized system points.

In block 535, routine 500 identifies, from among a plurality of registered developers, a developer that created, published, or otherwise corresponds to the reporting application.

In block 540, routine 500 credits the normalized system-point-award value, as computed in subroutine block 600, to a user-specific system-point balance corresponding to the user.

In block 545, routine 500 creates and/or updates an attribution record attributing to the developer (identified in block 535) a portion of the user-specific system-point balance that corresponds to the normalized system-point-award value computed in subroutine block 600. For example, in one embodiment, routine 500 may update one or more records in database 340 to credit the awardable system points to the given user and to attribute those points to the developer.

In ending loop block 550, routine 500 iterates back to opening loop block 510 to process the next activity report, if any.

Once all activity reports have been processed, routine 500 ends in ending block 599.

FIG. 6 illustrates a subroutine 600 for computing a normalized system-point-award value award from a given activity report, such as may be performed by an inter-application redemption server 300 in accordance with one embodiment.

In block 605, subroutine 600 obtains the given activity report, e.g. from the calling routine and/or by accessing database 340.

In decision block 610, subroutine 600 determines (e.g., by querying database 340) whether the given user has previously been awarded points for using the reporting application. If so, then subroutine 600 proceeds to block 615; otherwise, subroutine 600 proceeds to block 620.

In block 615, subroutine 600 obtains (e.g., by querying database 340) a value indicating the maximum achievement-award value that the given user has previously earned in a span equal to the given duration (or other activity quantity).

For example, in one embodiment, database 340 may include a record indicating that the given user has previously earned as many as 10 application points in a minute, or 600 application points in an hour, or the like. In such an embodiment, if the given time duration is 30 minutes, then subroutine 600 may determine that the given user had previously earned a maximum quantity of 300 application points over the given 30-minute duration.

Otherwise, if the user has not previously been awarded points for using the reporting application, then in block 620, subroutine 600 determines an achievement-award value that an average user earns in the reporting application over the given time duration (or other activity quantity). In some embodiments, if no user has ever recorded a point award in the reporting application, subroutine 600 may compute a default value, such as an achievement-award value that an average user earned in an average application, or use a predetermined static default value (e.g., 500 applications-specific points per hour).

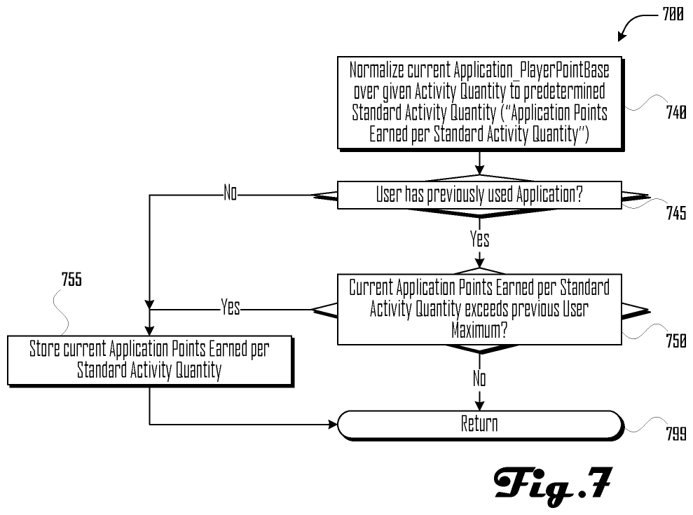

In the description herein, the quantity determined in either of block 615 or block 620 is referred to as “APP_PlayerPointBase”. In subroutine block 700, subroutine 600 calls subroutine 700 (see FIG. 7, discussed below) to (if necessary) update the value that that will be used as APP_PlayerPointBase the next time the given user earns points in the reporting application.

In block 625, subroutine 600 compares the given achievement-award value earned (e.g., 450) to APP_PlayerPointBase (e.g., 300) to obtain a normalized user point ratio. For example, in one embodiment, subroutine 600 may determine normalized user point ratio by determining the ratio of the application points earned (as obtained in block 605, e.g. 450) to the sum of application points earned (e.g., 450) and APP_PlayerPointBase (as determined in block 615 or block 620, e.g., 300) to obtain a normalized user point ratio such as 0.6.

In block 630, subroutine 600 determines a system-point scale for the given application-use duration (or other activity quantity). For example, in one embodiment, the system may have a predetermined maximum number of system points that can be earned in a given unit of time. For example, in one embodiment, the system may have a predetermined a cap of 3.33 system points per minute or 200 system points per hour (regardless of how many application points a user may have earned). Using the predetermined system-point cap (e.g., 200 system points per hour) and the given application-use duration (or other activity quantity) (e.g., 30 minutes), subroutine 600 may determine that a user may earn no more than, e.g., 100 system points in the given 30-minute application-use duration (or other activity quantity). In other words, in one embodiment, subroutine 600 determines that the system-point scale for the given application-use duration (or other activity quantity) is between 0 and 100 system points.

In block 635, subroutine 600 determines a quantity of awardable system points in proportion to the normalized user point ratio (determined in block 625) and the system-point scale for the given application-use duration (determined in block 815, e.g.). For example, in one embodiment, subroutine 600 may determine a quantity of 60 awardable system points, given a normalized user point ratio of 0.6 and a system-point scale of 0-100.

Subroutine 600 ends in ending block 699, returning to the caller the awardable system points determined in block 635.

The following pseudo-code illustrates one simplified exemplary implementation of subroutine 600.

TABLE-US-00001 function convertPoints (APP_PointsEarnedByPlayer, APP_TimeUnitsPlayedByPlayer, APP_MaxPointsPerTimeUnitEverEarnedByPlayerPlayingThisGame) {APP_AvgPointsPerTimeUnitInThisGame=250 SYSTEM_MaxPointsEarnablePerTimeUnit=200 SYSTEM_PointScaleForTimeUnitsPlayed=APP_TimeUnitsPlayedByPlayer*SYSTEM_MaxPointsEarnablePerTimeUnit APP_PlayerPointBase=APP_TimeUnitsPlayedByPlayer*APP_MaxPointsPerTimeUnitEverEarnedByPlayerPlayingThisGame ? APP_AvgPointsPerTimeUnitInThisGame NormalizedPlayerPointRatio=APP_PointsEarnedByPlayer/(APP_PointsEarnedByPlayer+APP_PlayerPointBase) SYSTEM_PointsAwardable=SYSTEM_PointScaleForTimeUnitsPlayed*NormalizedPlayerPointRatio return SYSTEM_PointsAwardable}

Other embodiments may include various alternatives, such as placing upper and/or lower limits on the number of application points that are used as the basis for computing a quantity of system points. Such upper and/or lower limits may be used in some embodiments to “tune” the algorithm so that users of varying skill levels are incentivized to continue using applications. For example, the following pseudo-code illustrates a simplified exemplary implementation of such an embodiment of subroutine 600.

TABLE-US-00002 function convertPoints (APP_PointsEarnedByPlayer, APP_TimeUnitsPlayedByPlayer, APP_MaxPointsPerTimeUnitEverEarnedByPlayerPlayingThisGame=500) {APP_MaxPointsPerTimeUnit=750 APP_MinPointsPerTimeUnit=50 APP_AvgPointsPerTimeUnitInThisGame=250 APP_AdjustedPointsEarnedByPlayer=Math.min(Math.max(APP_PointsEarnedByPlayer, APP_MinPointsPerTimeUnit*APP_TimeUnitsPlayedByPlayer), APP_MaxPointsPerTimeUnit*APP_TimeUnitsPlayedByPlayer) APP_AvgPointsPerTimeUnitInThisGame=250 SYSTEM_MaxPointsEarnablePerTimeUnit=200 SYSTEM_PointScaleForTimeUnitsPlayed=APP_TimeUnitsPlayedByPlayer*SYSTEM_MaxPointsEarnablePerTimeUnit APP_PlayerPointBasePerTimeUnitsPlayed=APP_TimeUnitsPlayedByPlayer*APP_MaxPointsPerTimeUnitEverEarnedByPlayerPlayingThisGame ? APP_AvgPointsPerTimeUnitInThisGame NormalizedPlayerPointRatio=APP_AdjustedPointsEarnedByPlayer/(APP_PointsEarnedByPlayer+APP_PlayerPointBasePerTimeUnitsPlayed) SYSTEM_PointsEarned=SYSTEM_PointScaleForTimeUnitsPlayed*NormalizedPlayerPointRatio return SYSTEM_PointsEarned}

The following pseudo-code illustrates yet another simplified exemplary implementation of subroutine 600, in which the algorithm may be “tuned” by adjusting values for HighBoundaryFactor (e.g., between 0.5-2.0) and LowBoundaryFactor (e.g., between 0.0-1.0).

TABLE-US-00003_secondsPerHour=3600 APP_MaxPointsEverEarnedByThePlayerBySecondsPlayed=APP_SecondsPlayedByPlayer*APP_MaxPointsPerHourEverEarnedByPlayer SYSTEM_MaxPointsEarnableBySecondsPlayed=SYSTEM_MaxPointsEarnablePerHour*APP_SecondsPlayedByPlayer SYSTEM_PointsEarned=((_secondsPerHour*APP_PointsEarnedByPlayer*HighBoundaryFactor+LowBoundaryFactor*SYSTEM_MaxPointsEarnableBySecondsPlayed)*SYSTEM_MaxPointsEarnableBySecondsPlayed)/(_secondsPerHour*_secondsPerHour*APP_PointsEarnedByPlayer+_secondsPerHour*APP_MaxPointsEverEarnedByThePlayerBySecondsPlayed)

In still other embodiments, the system may include additional functionality related to system-point accumulation, such as fraud detection, which may consider factors such as whether a given user is reporting points earned in a short period of time from widely dispersed geolocations (e.g., a user reports earning points from an IP address probably located in North America, and then 10 minutes later reports earning points from an IP address probably located in Eastern Europe), whether a given user is reporting points earned in an implausible application-use duration (e.g., using an application for 25 hours during one calendar day), whether a given user is reporting to have earned an implausible quantity of points earned (e.g., if users tend to earn on the order of 100 points per hour in a given application, but the given user has reported earning 10000 points in that time), and the like.

FIG. 7 illustrates a subroutine 700 for updating a given APP_PlayerPointBase value for a given user, a given duration (or other activity quantity), and a given reporting application, such as may be performed by an inter-application redemption server 300 in accordance with one embodiment.

In block 740, subroutine 700 normalizes the given APP_PlayerPointBase, earned over the given duration (or other activity quantity), to a predetermined standardized duration (e.g., one hour, one minute, or the like), referred to in FIG. 7 as “Application Points Earned per Standard Activity Quantity. For example, in one embodiment, subroutine 700 may convert a given application-point award of, e.g., 450, earned over a duration (or other activity quantity) of, e.g., 30 minutes, to a normalized value of, e.g., 900 for a predetermined standardized duration of, e.g., one hour.

In decision block 745, subroutine 700 determines whether the given user has previously used and been awarded application points in the given application. If not, then subroutine 700 proceeds to block 755. Otherwise, if in decision block 745, subroutine 700 determines that the given user has previously used and earned points in the given application, then subroutine 700 proceeds to decision block 750.

In decision block 750, subroutine 700 determines whether the current value of Application Points Earned per Standard Activity Quantity exceeds a previously stored value (e.g., previously stored in database 340 by a previous invocation of subroutine 700). If so, then subroutine 700 proceeds to block 755. Otherwise, subroutine 700 ends in ending block 799.

In block 755, subroutine 700 stores (e.g., in database 340) the current value of Application Points Earned per Standard Activity Quantity to be used as APP_PlayerPointBase the next time the used earns application points in the given application.

Subroutine 700 ends in ending block 799, returning to the caller.

FIG. 8 illustrates a routine 800 for processing promotional-offer descriptions, such as may be performed by an inter-application redemption server 300 in accordance with one embodiment.

In block 805, routine 800 obtains one or more promotional-offer descriptions describing one or more promotional offers that an offer provider (e.g., offer provider 215) wishes to be made available to application users in exchange for “points”. For example, in various embodiments, offer providers may wish to promote a brand and/or drive traffic to a virtual or physical storefront by offering discounts, gifts, or the like to users who wish to redeem points they have earned while using one or more computer applications.

Beginning in opening loop block 810, routine 800 processes each promotional-offer description in turn.

In various embodiments, the data describing the promotional offers may include data such as a “cost” (in system points) of the promotional offer (e.g., 1000 points), a description of the promotional offer (e.g., “10% of any regular-priced item”), as well as promotional copy and/or creative assets to be displayed to the player in connection with the promotional offer. In block 815, routine 800 determines a “cost” (in system points) of the current promotional offer.

In block 820, routine 800 stores (e.g., in database 340) a promotional-offer record for subsequent access and/or use.

In ending loop block 825, routine 800 iterates back to opening loop block 810 to process the next promotional-offer description, if any.

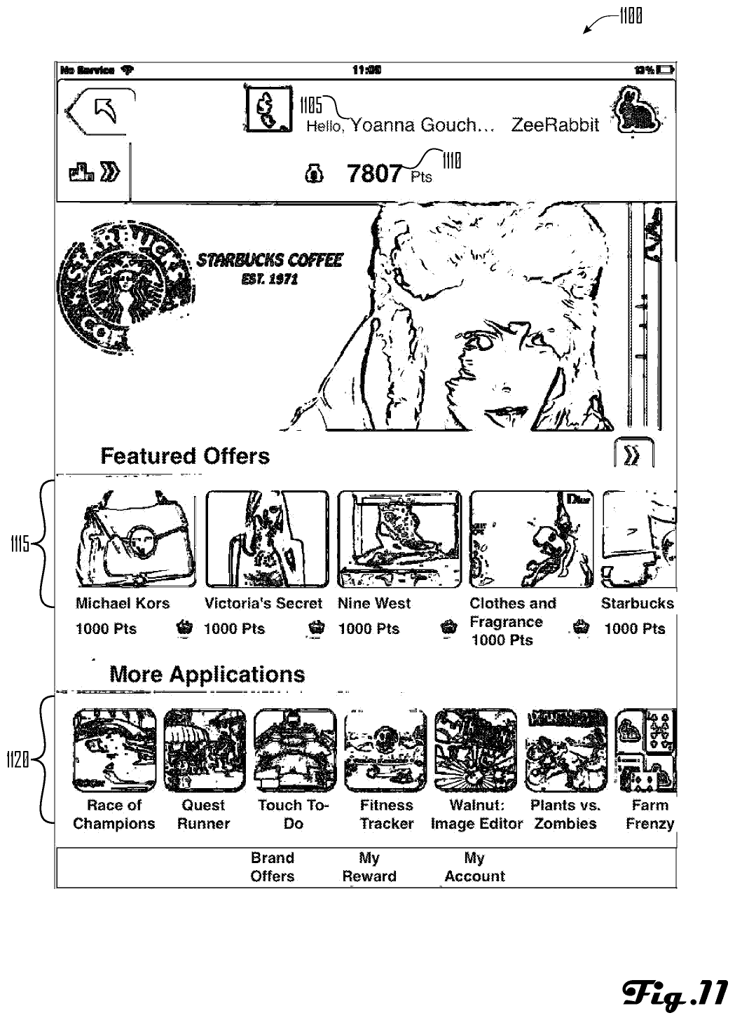

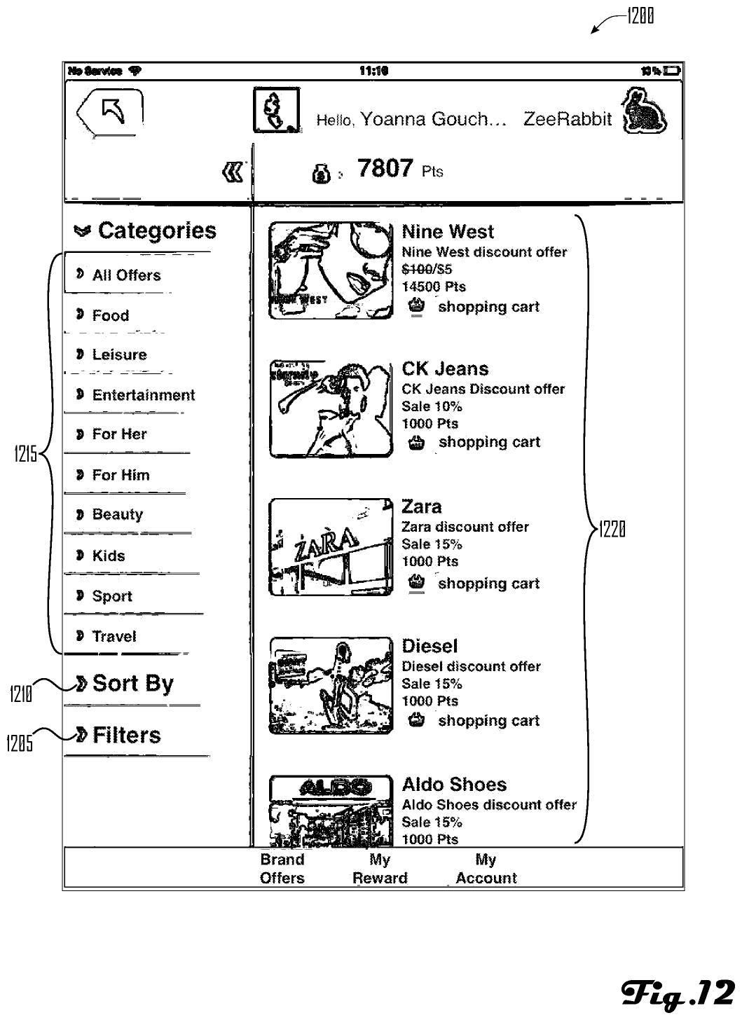

In block 830, routine 800 provides a promotional-offer selection user interface. See, e.g., promotional offer selection user interface 1100 (FIG. 11) and promotional-offer-selection user interface 1200 (FIG. 12), discussed below.

Routine 800 ends in ending block 899.

FIG. 9 illustrates a routine 900 for processing an offer-redemption request, such as may be performed by an inter-application redemption server 300 in accordance with one embodiment.

In block 905, routine 900 obtains a request (e.g., from a client device) to redeem a given promotional offer in exchange for a quantity of system points previously accumulated by a given user.

In block 910, routine 900 validates the redemption request, which may include authenticating the user as being who he or she claims to be, and the like.

In block 915, routine 900 determines a total quantity of credits associated with the redeemed offer. Typically, this quantity corresponds to the “price” (e.g., 1000 system points) that the user gives up in exchange for obtaining the offer.

In block 920, routine 900 determines an “inbound” currency value corresponding to the total credit quantity determined in block 915. As discussed above, inbound and outbound currency values are typically denominated in a “real-world” currency. For example, in one embodiment, a system point may have an “inbound” currency value (e.g., 0.00075 USD) that is greater than an “outbound” currency value (e.g., 0.000375 USD). Consequently, in such an embodiment, 1000 system-points-redeemed may have an inbound currency value of 0.75 USD and an outbound currency value of 0.375 USD.

In block 925, routine 900 debits the inbound currency value from an account associated with the offer provider. In some embodiments, an offer provider may pay for a certain number of offer redemptions in advance, and debiting the offer provider's account may include crediting an account associated with the system operator. In other embodiments, an offer provider may pay after the fact, and the system provider may invoice the offer provider periodically to collect for offers that users have redeemed.

In subroutine block 1000, routine 900 distribute a developer-portion of the inbound currency value among developers that contributed to the user's system point total.

Routine 900 ends in ending block 999.

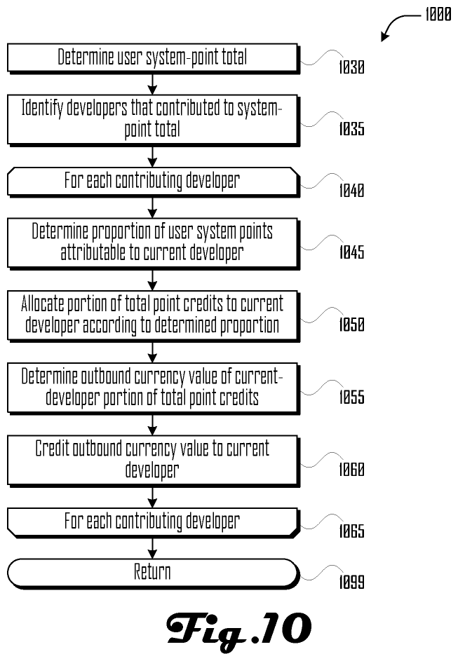

FIG. 10 illustrates a subroutine 1000 for distributing a developer-portion of an offer-redemption currency-cost, such as may be performed by an inter-application redemption server 300 in accordance with one embodiment.

In block 1030, subroutine 1000 determines a total quantity of system points that the given user has accumulated (e.g., 2000 system points).

In block 1035, subroutine 1000 identifies one or more developers to whom the user's system points are attributable (e.g., developers A and B).

Beginning in opening loop block 1040, subroutine 1000 processes each contributing developer in turn.

In block 1045, subroutine 1000 determines a proportion of the user's total system points that are attributable to the current developer. For example, in one embodiment, 40% of the user's total system points may be attributable to developer A, and 60% to developer B.

In block 1050, subroutine 1000 allocates the total point credits for the redeemed offer (as determined in block 915 of FIG. 9) to the current developer in the proportion determined in block 1045. For example, in one embodiment, if the user redeemed 1000 point credits, developer A may be allocated 40% of the points and developer B may be allocated 60% of the points.

In block 1055, subroutine 1000 determines an outbound currency value corresponding to the current developer's allocated credit portion.

In block 1060, subroutine 1000 credits an account associated with the current developer with the determined outbound currency value. For example, in one embodiment, developer A may be credited with 0.4*1000*0.375 USD, and developer B may be credited with 0.6*1000*0.375 USD

In ending loop block 1065, subroutine 1000 iterates back to opening loop block 1040 to process the next contributing developer, if any.

Once all contributing developers have been processed, subroutine 1000 ends in ending block 1099, returning to the caller.

FIG. 11 illustrates aspects of an exemplary user interface, such as may be displayed on a client computing device 205 in accordance with one embodiment. More particularly, FIG. 11 illustrates a promotional offer selection user interface 1100.

Promotional offer selection user interface 1100 includes an element 1105 identifying the user who is logged in to the system; an element 1110 displaying the quantity of system points that the user has previously accumulated; a list of promotional offers 1115 that may be available to redeem; and a list of applications 1120 that the user can obtain and use to accumulate additional system points.

FIG. 12 illustrates aspects of an exemplary user interface, such as may be displayed on a client computing device 205 in accordance with one embodiment. More particularly, FIG. 12 illustrates a promotional-offer-selection user interface 1200.

Promotional-offer-selection user interface 1200 includes a filter control 1205 and a sort control 1210 for providing additional criteria by which list 1220 may be sorted and/or filtered.

Promotional-offer-selection user interface 1200 also includes a list of selectable categories 1215 and a list 1220 of selectable promotional offers that match the selected criteria.

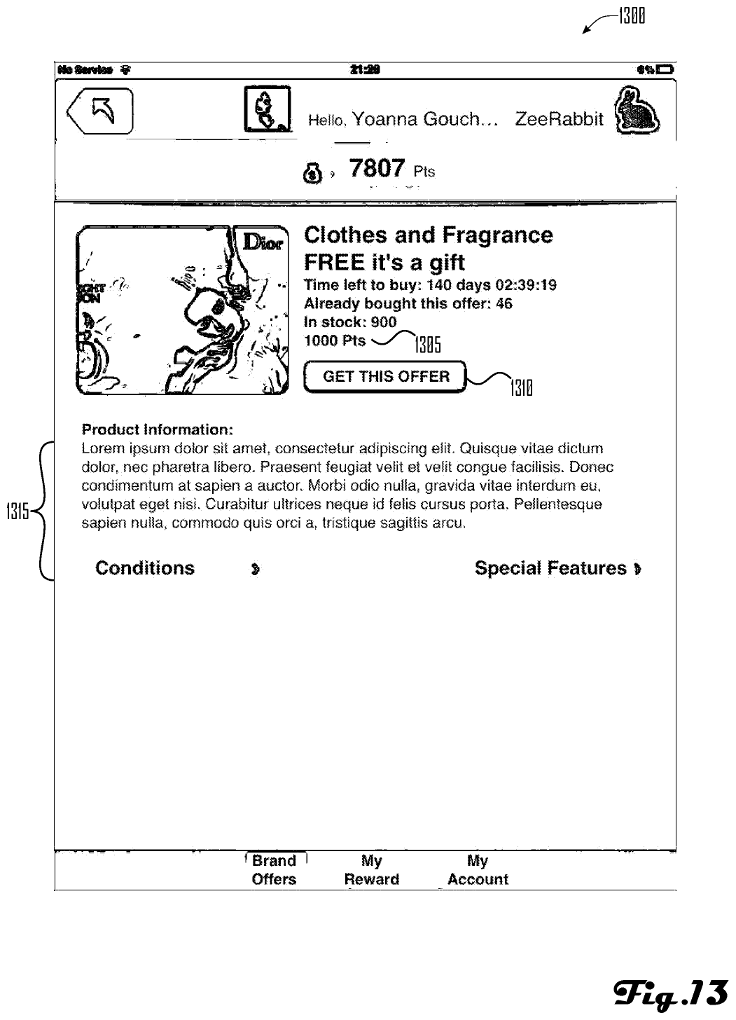

FIG. 13 illustrates aspects of an exemplary user interface, such as may be displayed on a client computing device 205 in accordance with one embodiment. More particularly, FIG. 13 illustrates a promotional-offer-redemption user interface 1300 for reviewing and obtaining a selected promotional offer.

Promotional-offer-redemption user interface 1300 includes an element 1305 indicating the quantity of system points that will be debited from the user's total in exchange for the promotional offer; a redeem-offer control 1310 for obtaining the promotional offer in exchange for the indicated quantity of system points; and an elements 1315, which provide additional information (or access to additional information) about the selected promotional offer.

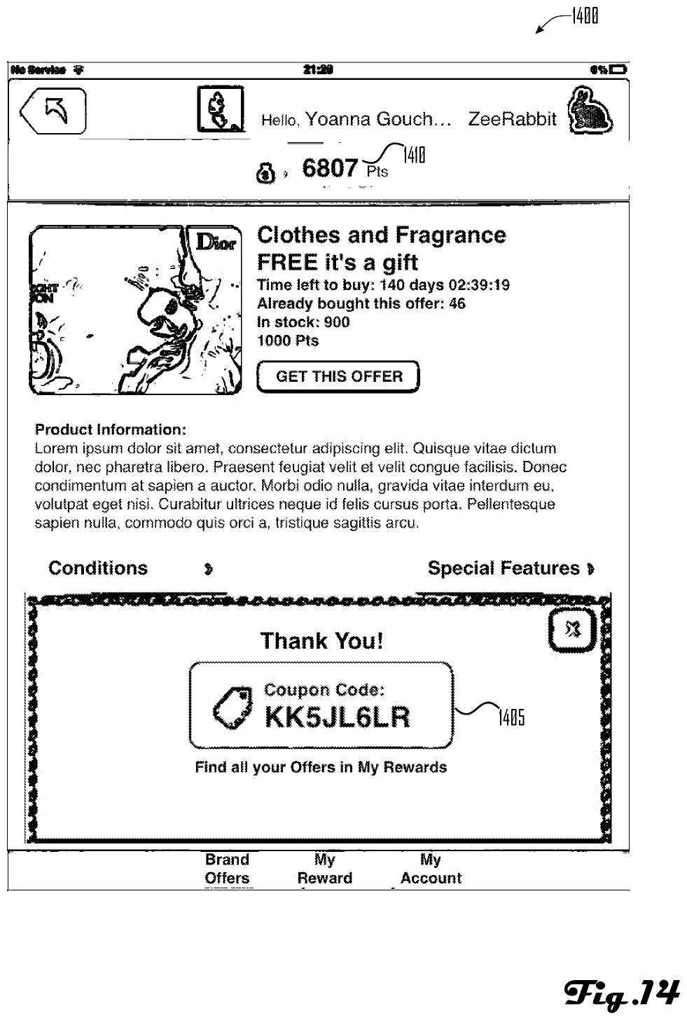

FIG. 14 illustrates aspects of an exemplary user interface, such as may be displayed on a client computing device 205 in accordance with one embodiment. More particularly, FIG. 14 illustrates a promotional-offer redemption-token user interface 1400.

Promotional-offer redemption-token user interface 1400 includes an offer redemption token 1405 showing a human-readable code that when presented at a physical or virtual storefront, will entitle the user to a free gift; and a display element 1410 showing the quantity of system points remaining to the user after redemption of the selected offer.

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1-20. (canceled)

21. A method for inter-application game achievement normalization, comprising:
receiving, by a server device via a plurality of game applications executing on at least one remote computing device, a plurality of activity reports associated with a user and geolocation information about the user; and in response to receiving a “current” activity report of said plurality of activity reports:
determining, by said server device from among a plurality of registered game applications, an indicated application that reported said current activity report;
determining, by said server device, an indicated achievement-award value measuring, according to an application-specific unit of achievement, an achievement reached by said user;
computing, by said server device, a normalized system-point-award value, measured according to a non-application-specific unit of achievement and adjusted such that system points accumulate at rates that encourage users of varying skill levels to keep playing the plurality of game applications; and
crediting, by said server device, said normalized system-point-award value to a user-specific system-point balance corresponding to said user.

22. The method of claim 21, wherein the application-specific unit of achievement is based on the level of difficulty of the achievement.

23. The method of claim 22, wherein the level of difficulty of the achievement is based on the amount of time that an accomplished user takes to complete the achievement.

24. The method of claim 21, wherein the amount of activity is the time required to achieve the level of achievement.

25. The method of claim 21, wherein computing said normalized system-point-award value comprises:
determining a baseline achievement-award value, measured in said application-specific unit of achievement, for said user based at least in part on said indicated activity quantity;
determining a system-point scalar based at least in part on said indicated activity quantity and said unit of activity; and
computing said normalized system-point-award value based at least in part on said indicated achievement-award value, said baseline achievement-award value, and said system-point scalar.

26. The method of claim 25, wherein determining said baseline achievement-award value comprises:
determining a baseline quantity of said unit of activity; and
determining a maximum quantity of said application-specific unit of achievement per said baseline quantity of said unit of activity that said user has previously reached according to said indicated application.

27. The method of claim 25, wherein determining said baseline achievement-award value comprises determining an expected quantity of said application-specific unit of achievement per a baseline quantity of said unit of activity that a typical user reaches according to said indicated application.

28. The method of claim 21, further comprising providing an activity-manager user interface to enable said user to access said plurality of activity reports received via said plurality of applications, and said normalized system-point-award values computed therefrom.

29. An apparatus for processing inter-application game achievement awards, the apparatus comprising a processor and a memory storing instructions that, when executed by the processor, configure the apparatus to:
receive, via a plurality of game applications executing on at least one remote computing device, a plurality of activity reports associated with a user and geolocation information about the user; and in response to receiving a “current” activity report of said plurality of activity reports:
determine, from among a plurality of registered game applications, an indicated application that reported said current activity report;
determine an indicated achievement-award value measuring, according to an application-specific unit of achievement, an achievement reached by said user;
determine an indicated activity quantity measuring, according to a unit of activity, an amount of an activity performed by said user that contributed to reaching said achievement; and
compute a normalized system-point-award value, measured according to a non-application-specific unit of achievement and adjusted such that system points accumulate at rates that encourage users of varying skill levels to keep playing the plurality of game applications.

30. The computing apparatus of claim 29, wherein the application-specific unit of achievement is based on the level of difficulty of the achievement.

31. The computing apparatus of claim 30, wherein the level of difficulty of the achievement is based on the amount of time that an accomplished user takes to complete the achievement.

32. The computing apparatus of claim 29, wherein the amount of activity is the time required to achieve the level of achievement.

33. The apparatus of claim 29, wherein the instructions that configure the apparatus to compute said normalized system-point-award value further comprise instructions configuring the apparatus to:
determine a baseline achievement-award value, measured in said application-specific unit of achievement, for said user based at least in part on said indicated activity quantity;
determine a system-point scalar based at least in part on said indicated activity quantity and said unit of activity; and
compute said normalized system-point-award value based at least in part on said indicated achievement-award value, said baseline achievement-award value, and said system-point scalar.

34. The apparatus of claim 33, wherein the instructions that configure the apparatus to determine said baseline achievement-award value further comprise instructions configuring the apparatus to:
determine a baseline quantity of said unit of activity; and
determine a maximum quantity of said application-specific unit of achievement per said baseline quantity of said unit of activity that said user has previously reached according to said indicated application.

35. A non-transient computer-readable storage medium having stored thereon instructions that, when executed by a processor, configure the processor to:
receive, via a plurality of game applications executing on at least one remote computing device, a plurality of activity reports associated with a user and geolocation information about the user; and in response to receiving a “current” activity report of said plurality of activity reports:
determine, from among a plurality of registered applications, an indicated application that reported said current activity report;
determine an indicated achievement-award value measuring, according to an application-specific unit of achievement, an achievement reached by said user;
determine an indicated activity quantity measuring, according to a unit of activity, an amount of an activity performed by said user that contributed to reaching said achievement; and
compute a normalized system-point-award value, measured according to a non-application-specific unit of achievement and adjusted such that system points accumulate at rates that encourage users of varying skill levels to keep playing the plurality of game applications.

36. The computing apparatus of claim 35, wherein the application-specific unit of achievement is based on the level of difficulty of the achievement.

37. The computing apparatus of claim 36, wherein the level of difficulty of the achievement is based on the amount of time that an accomplished user takes to complete the achievement.

38. The computing apparatus of claim 35, wherein the amount of activity is the time required to achieve the level of achievement.

39. The storage medium of claim 35, wherein the instructions that configure the processor to compute said normalized system-point-award value further comprise instructions configuring the processor to:
determine a baseline achievement-award value, measured in said application-specific unit of achievement, for said user based at least in part on said indicated activity quantity;
determine a system-point scalar based at least in part on said indicated activity quantity and said unit of activity; and
compute said normalized system-point-award value based at least in part on said indicated achievement-award value, said baseline achievement-award value, and said system-point scalar.

40. The storage medium of claim 19, wherein the instructions that configure the processor to determine said baseline achievement-award value further comprise instructions configuring the processor to:
determine a baseline quantity of said unit of activity; and
determine a maximum quantity of said application-specific unit of achievement per said baseline quantity of said unit of activity that said user has previously reached according to said indicated application.
